(19) United States
(12) Patent Application Publication
(10) Pub. No.: US 2006/0253209 A1
(43) Pub. Date: Nov. 9, 2006

(54) SOUND PROCESSING WITH FREQUENCY TRANSPOSITION

(75) Inventors: Adam Hersbach, The Patch (AU); Hugh McDermott, Mt Macedon (AU); Ralph Peter Derleth, Hinwil (CH)

Correspondence Address: PEARNE & GORDON LLP, 1801 EAST 9TH STREET, SUITE 1200, CLEVELAND, OH, 44114-3108, US

(73) Assignee: Phonak AG, Stafa (CH)

(21) Appl. No.: 11/380,015

(22) Filed: Apr. 25, 2006

(30) Foreign Application Priority Data
Apr. 29, 2005 (AU) 2005201813

(51) Int. Cl. G06F 17/00

(52) U.S. Cl. 700/94

(57) ABSTRACT

There is disclosed, in one aspect, a signal processing device (100) including: processing means (108) for generating a spectral representation of an input sound signal; frequency transposition means (110) for transposing at least part of the input signal's spectral representation to a transposed output frequency, said frequency transposition means (110) being configured to process the portion of the input signal spectral representation such that a phase relationship that existed in the input signal's spectral representation is substantially maintained in the transposed portion of the spectral representation; and synthesis means (112) for generating an output signal including the transposed portion of the input signal. Associated methods of processing a received sound signal are also disclosed.

### FIELD OF THE INVENTION

The present invention relates to a sound processor and a method of sound processing.

### BACKGROUND OF THE INVENTION

Numerous frequency transposition schemes for the presentation of audio signals have been developed. In each case the principle aim of the frequency transposition is to improve the audibility and discrimination of signals in certain frequency bands by modifying those signals and presenting them to the user at different (typically lower) frequencies, where the user has better hearing ability.

One prior art frequency transposition method uses a fast Fourier transform (FFT) to convert a windowed sample set derived from an input audio signal into a set of frequency components that are arranged in a plurality of input frequency bins. In these previous systems, the frequency compressed output signal is generated by summing together sets of weighted input bins to produce each output bin according to the following general equation:

$${Y}_{n} ( {ω}_{k} ) = {\sum }_{m} {w}_{k} ( {ω}_{m} ) {X}_{n} ( {ω}_{m} ) \qquad ( 1 )$$

That is, the complex Fourier representation of output signal Yₙ(ωₖ) at sample n is calculated as the weighted vector sum of input frequencies Xₙ(ωₘ) indexed by m, where wₖ(ωₘ) are the weights applied to the contributing input bins to produce output bin k.

A linear frequency shift can be implemented by shifting all input frequencies by an integer number of FFT bins (K) with the weights set to unity (wₖ=1) and equation (1) is simplified to:
Tₙ(ωₖ)=Xₙ(ω_{k+K}) (2)

To implement this in a DSP where the complex representation of the signal is available as a set of real and imaginary components, the real and imaginary components of each input bin are copied to an output bin shifted down by K FFT bins, so as to place the output signal in the appropriate frequency region for the user.

However, with this implementation, the phase of the signal is not modified as the real and imaginary components are copied from one bin to another. This can lead to suboptimal performance of the audio processor device. The present inventor has determined that by taking account of phase information when conducting a frequency transposition operation in an audio processing device, such as a hearing aid, it may be possible to improve the quality of the output sound.

### SUMMARY OF THE INVENTION

In broad concept the present invention provides a system and method for applying a frequency transposition to an input sound signal in which a phase relationship that existed in the input signal spectral representation is substantially maintained in the output signal spectral representation.

According to a first aspect the present invention provides a method of processing a received sound signal including: processing the received audio signal to generate an input signal spectral representation of the received signal divided into a plurality of input signal frequency bins; transposing the input signal spectral representation from at least one input signal frequency bin into at least one output frequency bin; applying a correction to the transposed portion of the input signal spectral representation such that a phase relationship that existed in the input signal spectral representation is substantially maintained in the transposed portion of an output signal spectral representation; and generating a time domain output signal from the output signal spectral representation.

The method can further include: processing the input signal spectral representation of at least one input signal frequency bin to be transposed such that the frequency range of the input signal spectral representation is altered; and transposing the processed input signal spectral representation into a portion of at least one output frequency bin having a frequency range equal to the processed input signal spectral representation.

The phase relationship to be maintained can result in a frequency deviation of a spectral component in an input signal frequency bin from a centre frequency of said bin to be the same as a frequency deviation of a corresponding spectral component from a centre frequency of a corresponding output signal frequency bin after transposition.

The phase relationship to be maintained may result in a proportional frequency deviation of a spectral component in at least a portion of said input signal frequency bin from a centre frequency of said portion of the bin to be maintained in the processed signal spectral representation transposed into a portion of at least one output frequency bin.

In a preferred embodiment a phase correction applied to the transposed portion of the input signal spectral representation is equivalent to,

$$K \frac{2 π D}{N}$$

wherein, N is a number of samples in a frame of data to be processed, D is a number of samples between the start of successive frames of data to be processed, and K is a number of bins that the transposed portion of the input signal spectral representation is transposed.

Preferably the step of applying a correction to the transposed portion of the input signal spectral representation does not include determining the phase of the spectral component of, at least one of, an input signal frequency bin or an output signal frequency bin.

A phase correction can be implemented by performing at least one of the following operations: changing a sign of one or more of the real and imaginary components of the complex representation of the portion of the spectral representation to be transposed; and swapping the real and imaginary components of the complex representation of the portion of the spectral representation to be transposed.

Processing parameters are preferably selected such that the correction applied requires a phase shift that is an integer multiple of π/2.

According to a second aspect of the present invention there is provided a method of processing a received sound signal including the steps of: processing an input data set representing the received sound signal to generate a windowed data set; further processing the windowed data set, including transposing at least one input signal frequency bin of an input signal spectral representation component derived from the windowed dataset into at least one output frequency bin to generate an output signal spectral representation including the transposed spectral representation components and in which a phase relationship that existed in the input signal spectral representation is substantially maintained; and processing the output signal spectral representation to arrive at a time domain output signal dataset.

Further processing of the windowed data set can include: rotating the windowed data set by a predetermined number of samples to generate a rotated windowed dataset; processing the rotated windowed dataset to generate an input signal spectral representation divided into a plurality of input signal frequency bins; transposing the input signal spectral representation component belonging to at least one input signal frequency bin into at least one output frequency bin having a different frequency to said input frequency bin; generating an output signal spectral representation including the transposed spectral representation components; processing the output signal spectral representation to arrive at a time domain output signal dataset; and rotating the time domain output signal dataset by the predetermined number of samples to generate a rotated time domain output signal dataset in which a phase relationship that existed in the input signal spectral representation is substantially maintained..

The predetermined number of samples is preferably equal to the number of samples between the start of successive frames of data to be processed.

In certain embodiments the phase relationship to be maintained results in a frequency deviation of a spectral component in an input signal frequency bin from a centre frequency of said bin to be the same as a frequency deviation of a corresponding spectral component from a centre frequency of a corresponding output signal frequency bin after transposition.

According to a third aspect of the present invention there is provided a method of processing a received sound signal including the steps of: processing the received audio signal to generate an input signal spectral representation of the received signal divided into a plurality of input signal frequency bins; transposing the input signal spectral representation from at least one input signal frequency bin by a predetermined number of bins into at least one output frequency bin; such that a phase relationship that existed in the input signal spectral representation is substantially maintained in the transposed portion of the input signal spectral representation; and generating an output signal time domain representation of the processed signal.

The respective output frequency bin can be selected such that a frequency deviation of a spectral component in an input signal frequency bin from a centre frequency of said bin to be the same as a frequency deviation of a corresponding spectral component from a centre frequency of a corresponding output signal frequency bin after transposition.

Preferably the phase relationship to be maintained results in a proportional frequency deviation of a spectral component in at least a portion of said input signal frequency bin from a centre frequency of said portion of the bin to be maintained in the processed signal spectral representation transposed into a portion of at least one output frequency bin.

In the event that a plurality of input frequency bins are to be transposed into the same output frequency bins a peak picking algorithm is preferably used to select a spectral component of one or more of said input bins for output in said output frequency bin. The peak picking algorithm can sum the output corresponding to a plurality of input bins to generate the spectral component of the output frequency bin. Alternatively the peak picking algorithm may select the input bin having the largest magnitude spectral component for output in the output frequency bin.

Optionally, a spectral representation of one input frequency bin is transposed into a plurality of output frequency bins. Preferably, the spectral representation of each of a plurality of portions of the input frequency bin are transposed into different output frequency bins.

Optionally, the spectral representation of a plurality of input frequency bins are transposed into one output frequency bin. Preferably the spectral representation each of the input frequency bins are transposed into different portions of the output frequency bin.

According to a fourth aspect of the present invention there is provided a signal processing device including: processing means for generating a spectral representation of an input sound signal; frequency transposition means for transposing the at least part of the input signal's spectral representation to a transposed output frequency, said frequency transposition means being configured to process the portion of the input signal spectral representation such that a phase relationship that existed in the input signal's spectral representation is substantially maintained in the transposed portion of the spectral representation; and synthesis means for generating an output signal including the transposed portion of the input signal.

The signal processing can further include a spectral representation range alteration block configured to either compress or expand the frequency range of at least part of the transposed spectral representation.

The frequency transposition means can also be configured to apply a correction to the transposed signal such that a frequency deviation of a spectral component in an input signal frequency bin from a centre frequency of said bin is the same as a frequency deviation of the transposed spectral component from a centre frequency of a corresponding output signal frequency bin.

The frequency transposition means may be configured to apply a correction to the transposed signal such that a proportional frequency deviation of a spectral component in an input signal frequency bin from a centre frequency of a portion of at least one said bin is the same as a proportional frequency deviation of the transposed spectral component from a centre frequency of at least one corresponding output signal frequency bin.

The signal processing can further include data rotation means for rotating a frame of the input signal such that a phase relationship that exists in the input signal's spectral representation will be substantially maintained in the transposed portion of the spectral representation. The data rotation means can be further configured to rotate the transposed portion of the spectral representation prior to the generation of the output signal.

The transposition means preferably applies a phase correction which is equivalent to,

$$K \frac{2 π D}{N}$$

wherein, N is a number of samples in a frame of data to be processed, D is a number of samples between the start of successive frames of data to be processed, and K is a number of bins that the transposed portion of the input signal spectral representation is transposed.

In some embodiments the phase relationship to be maintained results in a frequency deviation of a spectral component in an input signal frequency bin from a centre frequency of said bin to be the same as a frequency deviation of a corresponding spectral component from a centre frequency of a corresponding output signal frequency bin after transposition.

### BRIEF DESCRIPTION OF THE DRAWINGS

Preferred embodiments of the present invention will now be described by way of non-limiting example only with reference to the accompanying drawings in which:

FIG. 1 depicts a schematic view of a processing system for applying a frequency transposition to an audio signal in accordance with an embodiment of the present invention;

FIG. 2 depicts a schematic view of a processing system for applying a frequency transposition to an audio signal in accordance with a second embodiment of the present invention;

FIG. 3 is a flowchart illustrating the steps in a method according to an embodiment of the present invention;

FIG. 4 is a flowchart illustrating the steps in a method according to another embodiment of the present invention;

FIG. 5 is a diagram illustrating a frequency mapping function that can be used to maintain a predetermined phase relationship in an output signal in an embodiment of the present invention;

FIG. 6 shows a schematic representation of an exemplary set of input and output signals with respective phasors for a situation in which a compressive frequency shift is implemented illustrating how overlap can occur in the output signal;

FIG. 7 shows an alternative set of input and output signals, with respective phasors, for a signal that undergoes a compressive frequency shift which illustrates another case of overlap in the output signal;

FIG. 8 illustrates how bin overlap can be produced when a compressive frequency shift is implemented;

FIG. 9 illustrates how bin overlap is avoided when implementing a compressive frequency shift in an embodiment of the present invention;

FIG. 10 depicts schematically how a partial bin mapping arrangement can be employed in an embodiment of the present invention to avoid bin overlap when a compressive frequency shift is performed;

FIG. 11 illustrates a prior art scheme of FFT bin mapping employed in an expansive frequency shift; and

FIG. 12 illustrates a partial bin mapping technique used in an embodiment of the present invention for implementing an expansive frequency shift.

### DETAILED DESCRIPTION OF THE EMBODIMENTS

Several exemplary embodiments of the present invention will be described, by way of non limiting example only. Each of the examples described herein relate to hearing aids, however it should be noted that the present invention can find application in other types of devices, and the present invention should not be considered to be limited to use in hearing aids.

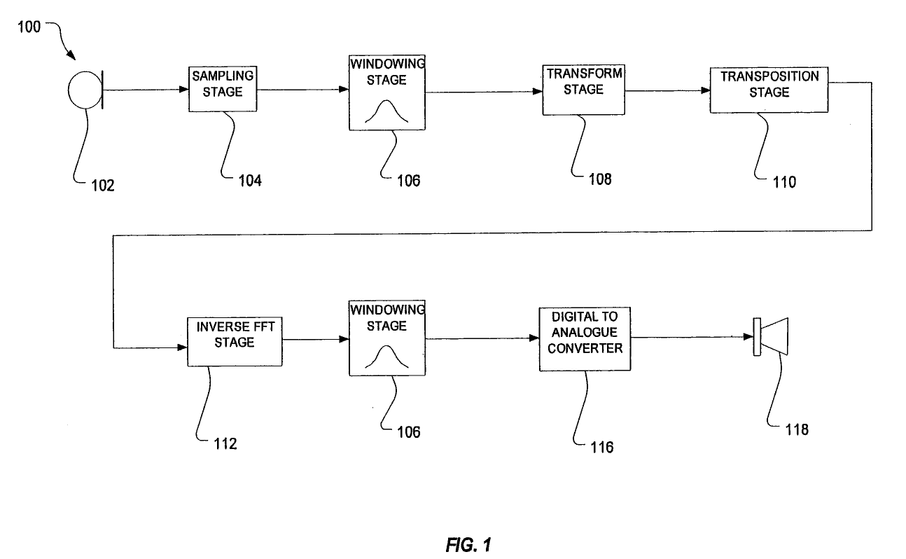

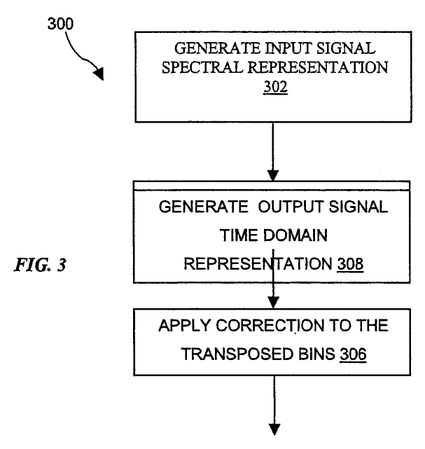

A first embodiment of the present invention will now be described in connection with the audio processing system depicted schematically in FIG. 1 and the process 300 illustrated in the flowchart of FIG. 3. This system 100 may be implemented as part of a hearing aid or other audio processing apparatus, such as a telecommunications device or the like.

Initially in step 302, a time varying input signal received by microphone 102 is digitally sampled by sampling stage 104. The sampled input signal then has an analysis window applied to each frame of data by windowing stage 106 and is then transformed using a digital fourier transform or fast Fourier transform (DFT or FFT) at the transform stage 108 to generate a complex spectral representation of the input signal. The DFT (or FFT) produces a complex value describing the magnitude and phase of the input signal at each frequency in a set of linearly spaced frequency bins. Next in step 304 the transposition stage 110 of the system 100 shifts the spectral components into output bins, at least one of those having a different frequency.

The inventor has identified that phase vocoder theory can be used to estimate the instantaneous frequency of the spectral component in each input frequency bin. Phase vocoder theory is explained in greater detail in the following documents, the contents of which are incorporated herein by reference. However, it should be noted that the applicants do not concede that these documents, or the information discussed therein, form part of the common general knowledge in the art in Australia at the priority date of the present application:

Dolson, M., The phase vocoder. A tutorial Computer Music Journal, 1987. 10(4): p. 14-27.

Flanagan, J. L. and R. M. Golden, Phase Vocoder. Bell Systems Technical Journal, 1966. 45: p. 1493-1509.

Moore, F. R., Elements of Computer Music. 1990: Prentice-Hall.

The instantanteous frequency \tilde{ω}ₖ of the spectral component in each FFT frequency bin k can be estimated by examining the phase change over time i.e. between successive FFT frames. Accordingly, the estimated instantaneous frequency \tilde{ω}ₖ of the spectral component in each FFT frequency bin k can be calculated by summing the bin centre frequency ωₖ and the deviation in frequency of the spectral component from the bin centre frequency δₖ. This is expressed as,
\tilde{ω}ₖ=ωₖ+δₖ (3)
where:
ωₖ=2πk/N is the centre frequency of bin k in rads⁻¹

$${δ}_{k} = \frac{1}{D} unwrap [ {Δϕ}_{n} ( {ω}_{k} ) - k \frac{2 π D}{N} ]$$

is the deviation in frequency of the spectral component in bin k from the bin's centre frequency. The unwrap function adds/subtracts successive values of 2π until the phase value is within the range [−π, π]
Δφₙ(ωₖ)=φₙ(ωₖ)−φ_{n-D}(ωₖ) is the phase difference between successive values of φₙ(ωₖ) in radians per D samples and can be viewed as a first order approximation of the time derivative of the phase angle.
k is the bin number
n is the sample number
N is the FFT size
D is the number of samples between the start of successive FFT frames

When performing a linear frequency shift of all frequencies by an integer number of FFT bins K, the real and imaginary components are copied from each bin k to bin k-K, and the phase change is modified by an amount Φ. In this case, the relationship between the phase change of the input FFT bin k and the shifted FFT bin k-K is:
Δφₙ(ω_{k-K})=Δφₙ(ωₖ)+Φ (4)

As discussed above, certain phase relationships that exist in the input sound signal can be chosen to be maintained in the regenerated signal. In this embodiment it is desirable that the frequency deviation δₖ from the centre frequency of input bin k to be the same as the frequency deviation δ_{k-K} from the centre frequency of transposed bin k-K, i.e.
δ_{k-K}=δₖ (5)
Expanding (5) by substituting

$${δ}_{k - K} = \frac{1}{D} unwrap [ {Δϕ}_{n} ( {ω}_{k} ) - ( k - K ) \frac{2 π D}{N} ]$$

and

$${δ}_{k} = \frac{1}{D} unwrap [ {Δϕ}_{n} ( {ω}_{k} ) - k \frac{2 π D}{N} ]$$

into it, gives

$$\frac{1}{D} unwrap [ {Δϕ}_{n} ( {ω}_{k - K} ) - ( k - K ) \frac{2 π D}{N} ] = \frac{1}{D} unwrap [ {Δϕ}_{n} ( {ω}_{k} ) - k \frac{2 π D}{N} ] \qquad ( 6 )$$

The square bracketed expressions can then be equated to obtain:

$${Δϕ}_{n} ( {ω}_{k - K} ) - ( k - K ) \frac{2 πD}{N} = {Δϕ}_{n} ( {ω}_{k} ) - k \frac{2 π D}{N} \qquad ( 7 )$$

and Δφₙ(ω_{k-K})=Δφₙ(ωₖ)+Φ (4) can be substituted directly into (7) to obtain:

$${Δϕ}_{n} ( {ω}_{k} ) + Φ - ( k - K ) \frac{2 πD}{N} = {Δϕ}_{n} ( {ω}_{k} ) - k \frac{2 π D}{N} . \qquad ( 8 )$$

This expression is then re-arranged to find:

$$Φ = K \frac{2 π D}{N} \qquad ( 9 )$$

Accordingly if desired, a phase correction can be applied in the transposed FFT bin k-K, by the transposition stage 110 in step 306, to ensure that the frequency deviation from the centre frequency of original bin k is the same as the frequency deviation from the centre frequency of transposed bin k-K.

In a preferred practical implementation, it is desirable to avoid the need to calculate phase change in the transposition stage 110, or more preferably, to avoid the need to calculate the phase angle of the signal in each transposed FFT bin. Rather, it is preferable to be able to simply apply a phase adjustment to the spectral component copied into the transposed FFT bin k-K. By careful selection of the parameters of the FFT processing stage this can be achieved as follows. First equation (4) is expanded to give;
Δφₙ(ω_{k-K})=Δφₙ(ωₖ)+Φ
φₙ(ω_{k-K})−φ_{n-D}(ω_{k-K})=φₙ(ωₖ)−φ_{n-D}(ωₖ)+Φ
at sample n=D, the initial conditions are set such that, φ₀(ω_{k-K})=φ₀(ωₖ)=0, so that the phase at bin k-K is calculated from the phase at bin k:

$${ϕ}_{n} ( {ω}_{k - K} ) = {ϕ}_{n} ( {ω}_{k} ) + \frac{n}{D} Φ , \frac{n}{D} = [ 1 , 2 , 3 … ] \qquad ( 10 )$$

FFT analysis frames are calculated every D samples when n/D=[1,2,3 . . . ] and n/D is the frame number. Substituting

$$Φ = K \frac{2 π D}{N}$$

(9) into (10) gives;

$${ϕ}_{n} ( {ω}_{k - K} ) = {ϕ}_{n} ( {ω}_{k} ) - \frac{n}{D} K \frac{2 π D}{N} \qquad ( 11 )$$

In the current example the FFT parameters are chosen to provide certain processing advantages, as will be apparent from the following. In this example, N=128 and D=32 so that 2πD/N=π/2. Under these conditions, and using a frequency shift of an integer number of bins i.e. K=[0,1,2 . . . j, the last term in (11) is always an integer multiple of π/2. Given that a phase adjustment of 2π rad is equivalent to an adjustment of 0 rad, we can calculate the corrected phase value by:

$${ϕ}_{n} ( {ω}_{k - K} ) = {ϕ}_{n} ( {ω}_{k} ) - \frac{π}{2} mod ( \frac{nK}{D} , 4 ) , mod ( \frac{nK}{D} , 4 ) = [ 0 , 1 , 2 , 3 ] \qquad ( 12 )$$

Accordingly, the phase adjustment required is always one of the four values, namely └0, π/2, π, 3π/2┘. These phase changes are easily implemented without the need actually calculate phase angles by conditionally changing the sign and/or swapping the real and imaginary components, depending on which quadrant in the unit circle the phase lies in.

In summary, a phase corrected linear shift of K bins is performed by implementing the following equation:

$${Y}_{n} ( {ω}_{k - K} ) = {X}_{n} ( {ω}_{k} ) {ⅇ}^{- j \frac{n}{D} K \frac{2 π D}{N}} \qquad ( 13 )$$

where X(ω) and Y(ω) are the complex Fourier transform representations of the input and output signals respectively, and the exponent term is the required phase change as calculated in equation (11).

Once the phase correction has been applied in step 306 by the transposition stage 110, the output signal spectral representation is then converted back into a time domain signal by the inverse FFT stage 112 for application to another windowing stage 114. The windowing stage 114 applies a synthesis window and recombines overlapping frames of data to generate a continuous output for the digital to analogue converter 116. This signal can then be provided (after suitable amplification, if necessary) to the receiver 118.

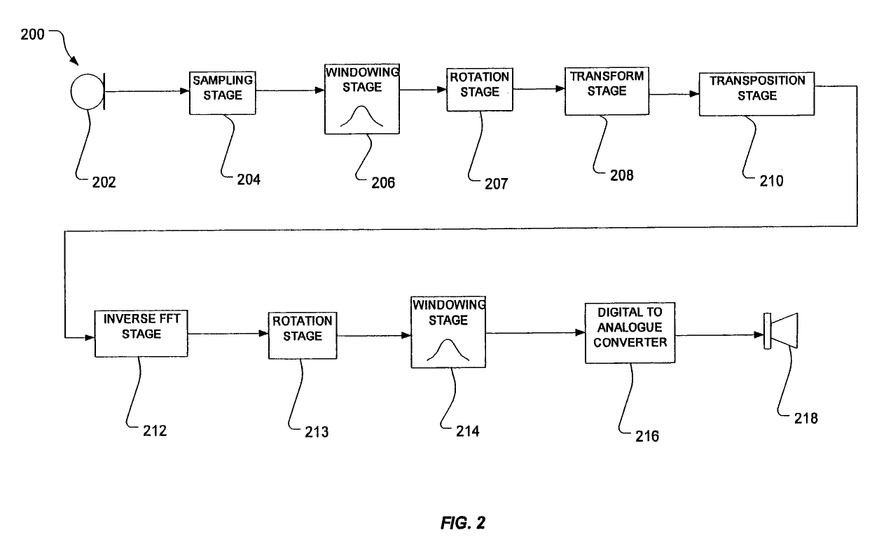

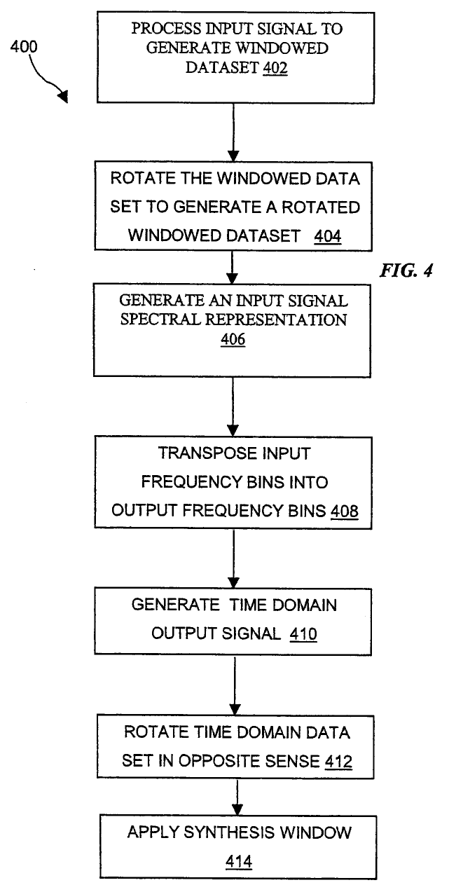

In an alternative embodiment, depicted in FIGS. 2 and 4, rather than adding (or subtracting) a phase correction to the transposed spectral components to maintain the desired phase relationship in the output signal, a phase shift is imparted to the signals by manipulating the input and output datasets appropriately. In particular in an embodiment of the present invention, the sequence of windowed input data is rotated before applying the FFT to avoid the need to apply a phase correction.

The method 400 (depicted in FIG. 4) begins by processing an input signal to generate a windowed data set 402. As in the previous embodiment a time varying input signal is received by the audio processing system 200 at microphone 202 and is then digitally sampled by sampling stage 204. The sampled input signal then has an analysis window applied to each frame of data by windowing stage 106. In step 404, prior to transformation by the transform stage 208 to generate a complex spectral representation of the input signal, a data rotation stage 207 rotates the FFT frame to generate a rotated windowed dataset. This rotation effectively adds a phase shift to the input FFT frames.

Taking the discrete Fourier transform (DFT) of a rotated sequence of N samples is equivalent to multiplying the spectrum X(k) by a complex exponential according to:

$$DFT [ x ( ( n - D ) mod N ) ] = X ( k ) {ⅇ}^{- j k \frac{2 π D}{N}} \qquad ( 14 )$$

It follows that when the data is rotated by D samples, the frequency deviation from the bin centre δₖ is not dependant on the bin number k, and is calculated by scaling the unwrapped phase change according to:

$${δ}_{k} = \frac{1}{D} unwrap [ {Δϕ}_{n} ( {ω}_{k} ) ] \qquad ( 15 )$$

This means that a given phase change Δφₙ(ωₖ) will give the same frequency deviation δₖ from the bin centre for all frequency bins, The phase correction Φ is therefore zero for a linear shift of any number of bins, and the real and imaginary components are simply copied from one bin to another—i.e. after rotating the data samples, a linear shift is implemented according to:
Yₙ(ω_{k-K})=Xₙ(ωₖ) (16)

In a DSP implementation, rotating the input data is straightforward and requires the rotation stage 207 to modify the pointer to its data buffer.

In step 406 an FFT stage generates a spectral representation of the rotated windowed dataset. Next in step 408, the transposition stage 210 of the system 200 shifts the spectral components into output bins at least one of those having a different frequency to the input FFT bins then, in step 410, an inverse FFT stage 212 converts the output spectrum into a time domain signal for application to a further windowing stage 214. However, prior to windowing the output data is rotated in step 412 in the opposite direction by D samples by a further rotation stage 213.

The windowing stage 214 then applies a synthesis window and recombines overlapping frames of data to generate a continuous output for the digital to analogue converter 216 in step 414. The signal can then be provided (with suitable amplification) to the receiver 218.

Embodiments of the present invention will now be described in connection with certain specific situations in order to better illustrate a range of implementations of the present invention. It should, however be noted that the examples given are not exhaustive, and embodiments of the present invention will find implementations in a wide variety of other situations.

As described in Australian patent application no. 2003236382, frequency transposition can be used as a feedback reduction mechanism. When used for this purpose, it is desirable that the frequency transposition be as small as possible so that a feedback reduction benefit is obtained, whilst minimising the hearer's ability to detect the transposed signal.

To implement frequency transposition as a feedback reduction mechanism in accordance with an embodiment of the present invention, a small frequency shift e.g. one FFT bin, is applied to all frequencies where feedback is likely to occur, whilst leaving other frequencies un-shifted. A typical hearing aid may leave frequencies below approximately 1500 Hz un-shifted, while shifting frequencies above 1500 Hz. There is no restriction that the frequency shift be in the direction of lowering the frequency, and a shift to higher frequencies also produces feedback reduction benefit. If the frequency shift is in the direction of lowering the frequency, an overlap will exist between the un-shifted and shifted bins. To deal with this overlap, the overlapping bins can be summed together to produce the output bin (i.e. sum the real and imaginary components of all overlapping bins). Alternatively, to deal with the overlap, the output bin is calculated by selecting the contributing bin with largest magnitude, and the information in the other bin(s) is discarded. Other methods of addressing the problem of overlapping bins are described below.

If the input data frames are not rotated prior to applying the FFT, a linear frequency shift of K bins is implemented by adjusting the phase of the shifted bins according to the amount of frequency shift;

$${Y}_{n} ( {ω}_{k - K} ) = {X}_{n} ( {ω}_{k} ) {ⅇ}^{- j \frac{n}{D} K \frac{2 π D}{N}} \qquad ( 17 )$$

This is implemented in a DSP by shifting the real and imaginary components from each input bin to each output bin, and conditionally modifying the sign and/or swapping the real and imaginary components as necessary, depending on which quadrant of the unit circle the phase lies in, as described above.

If the input data are rotated by D samples prior to applying the FFT, in accordance with the second illustrative embodiment described above, a linear frequency shift is implemented by simply copying the real and imaginary components from one bin to another without altering the phase.
Yₙ(ω_{k-K})=Xₙ(ωₖ) (18)

A second and opposite direction data rotation is also applied to the output signal after conducting the inverse FFT.

As described in Australian patent application no. 2002300314 and European patent application no. 04/005270.6, frequency shifting can be used to improve speech understanding for some people by presenting parts of the frequency spectrum in a more audible frequency range. Typically, the frequency shift is in the direction of lowering the frequency, and the relationship between input and output frequency is compressive in nature, where higher frequencies are shifted by a larger amount than lower frequencies. In addition, a region of low frequencies below a definable cut-off frequency typically remain un-shifted, so that only frequencies above the cut-off are shifted and compressed.

In embodiments of the present invention, a compressive frequency shift can be implemented in the following ways;

Phase Correction—Phase correction involves correcting the phase depending on the amount of frequency shift and then combining bins together, as described in the first embodiment above,

Data Rotation—Data rotation involves the rotation of the input data so that further phase correction is not necessary, then combines the bins together, as described in the second embodiment; or

Modified Mapping Function—In this case, input bins are processed in such a way that all bins are shifted by an amount which requires a phase correction of 2π (or integer multiple of 2π).

The application of each of these techniques will now be described in relation to the problem of performing a compressive frequency transposition of certain frequency components in a sound signal to improve audibility of a signal.

Turning firstly to the phase correction method. In this embodiment a compressive frequency shift is performed and overlapping frequency components are summed together to generate each output bin k. Each input bin is firstly adjusted in phase, and then a vector sum across all contributing bins is performed to obtain the desired output bin.

$${Y}_{n} ( {ω}_{k} ) = {\sum }_{m} {X}_{n} ( {ω}_{m} ) {ⅇ}^{- j \frac{n}{D} ( m - k ) \frac{2 π D}{N}} \qquad ( 19 )$$

where each bin in the group of m bins are phase corrected and summed together to produce each output bin k.

If the sampling and FFT parameters are chosen as described above, the exponent term,

$$\frac{n}{D} ( m - k ) \frac{2 π D}{N} ,$$

is always one of the values └0, π/2, π, 3π/2┘, and is easily implemented by altering the sign and/or swapping the real and imaginary components as necessary.

Depending on the analysis window size and the FFT length used in the implementation there may be significant frequency overlap between adjacent FFT bin filters. Under certain input signal conditions, several FFT bins in a contributing set may estimate the same frequency, and as they are phase adjusted and summed together according to equation (19) they will constructively/destructively interfere at some points in time. In this case, it may be preferable to first sum the contributing bins together and then apply the phase adjustment of equation (20) as set out below. The phase adjustment to be applied may change with the input signal, and depend on the strongest frequency component present in each contributing set of input bins that are combined together. One implementation of peak detection is to isolate the bin with maximum magnitude within the contributing set of input bins.

$${Y}_{n} ( {ω}_{k} ) = {ⅇ}^{- j \frac{n}{D} ( {m}_{max} - k ) \frac{2 π D}{N}} {\sum }_{m} {X}_{n} ( {ω}_{m} ) \qquad ( 20 )$$

where m is used to index each bin in the set of contributing bins, and mₘₐₓ is the index of the bin in that set which has largest magnitude. Again, in the current implementation, the phase change term

$$\frac{n}{D} ( {m}_{max} - k ) \frac{2 π D}{N}$$

is always one of the values [0, π/2, π, 3π/2┘ and can be implemented efficiently in a DSP by altering the sign and/or swapping the real and imaginary components as necessary.

The second method of implementing a compressive frequency shift is to rotate the windowed input data by D samples before the DFT is performed so the instantaneous frequency \tilde{ω}ₖ of each bin is estimated by

$${\tilde{ω}}_{k} = {ω}_{k} + {δ}_{k} \\ {\tilde{ω}}_{k} = \frac{2 π k}{N} + \frac{1}{D} unwrap [ {Δϕ}_{n} ( {ω}_{k} ) ] \qquad ( 21 )$$

Here, the frequency deviation δₖ from the bin centre is calculated from the phase change Δφₙ(ωₖ) and is independent of the frequency bin it is applied to. This means the same phase change in any bin will result in the same frequency deviation from the centre frequency of the bin to which it is applied. Therefore, when performing a frequency shift, no phase adjustment is necessary, and a compressive frequency shift is implemented by

$${Y}_{n} ( {ω}_{k} ) = {\sum }_{m}^{} {X}_{n} ( {ω}_{m} ) \qquad ( 21 )$$

The data must be rotated by −D samples at the output with the minus sign indicating that the direction of rotation is opposite to the rotation at the input. The rotation at the output is performed after the inverse FFT is done, and before the synthesis window is applied.

In the third embodiment, no data rotation or actual phase correction needs to be applied. Rather, the third embodiment maintains the chosen phase relationship of the input signal in the output signal by choosing an input to output frequency mapping function that is a piece-wise combination of linear shifts which approximates the desired compressive function. K is chosen for each piece-wise section so that

$$\frac{n}{D} K \frac{2 π D}{N} = a 2 π ,$$

where a is any integer. The phase adjustment is always an integer multiple of 2π rad and is equivalent to a phase change of 0 rad, therefore removing the need to perform a phase adjustment.

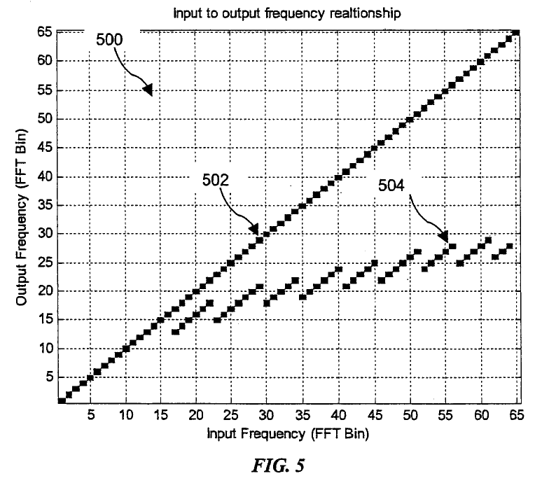

The input to output frequency relationship which approximates a compressive relationship of the form f′=f_{cutoff}^{1-CF}×f^{CF} with f_{cutoff}=2000 Hz and CF=0.5 is shown in FIG. 5. In FIG. 5 a piecewise defined transposition function 500 is defined which maps input frequency bins 502 to output bins 504. Using the analysis window size and the FFT length of the first embodiment, K is chosen to be an integer multiple of 4 to satisfy the conditions specified above.

In embodiments of the present invention in which a “compressive frequency shift” is implemented, i.e. more than one input bin is transposed into one output bin, distortions may be produced for some input signals and the output signal is not reconstructed as desired. As discussed above in relation to the use of frequency transposition as a feedback reduction mechanism, in some situations the problem of overlapping input bins can be dealt with by summing the real and imaginary components of all overlapping bins to produce the output bin, or the output bin can be calculated by selecting the contributing bin with largest magnitude, and discarding the information in the other bin(s).

FIG. 6 illustrates the type of problem that may be encountered in this situation. FIG. 6 shows schematically an input signal for a sound processor operating in accordance with the present invention. In this example, adjacent input FFT bins A, B and C are to be summed together to generate the output FFT bin D i.e. input FFT bins A, B and C overlap at the output. A problem arrises in this situation because a stimulus at the centre frequency of bin B generates FFT phasors with a phase relationship as shown diagrammatically 602A, 602B, 602C. Using phase vocoder theory to estimate the exact frequency of each phasor, A, B and C all estimate the same frequency at the centre of bin B. However, if they are summed together to produce the output D with the presumption that each phasor is estimating a frequency within the confines of its own FFT bin, distortions are introduced. In this case, A and C estimate frequencies outside the frequency range of their own respective bins. The result when these phasors are summed together to produce D is that phasors A and C will still estimate frequencies outside their own bin, and three frequency components will be generated at the output.

Thus it can be seen that in some situations the simple summing of output FFT bins can lead to unwanted components in the output signal.

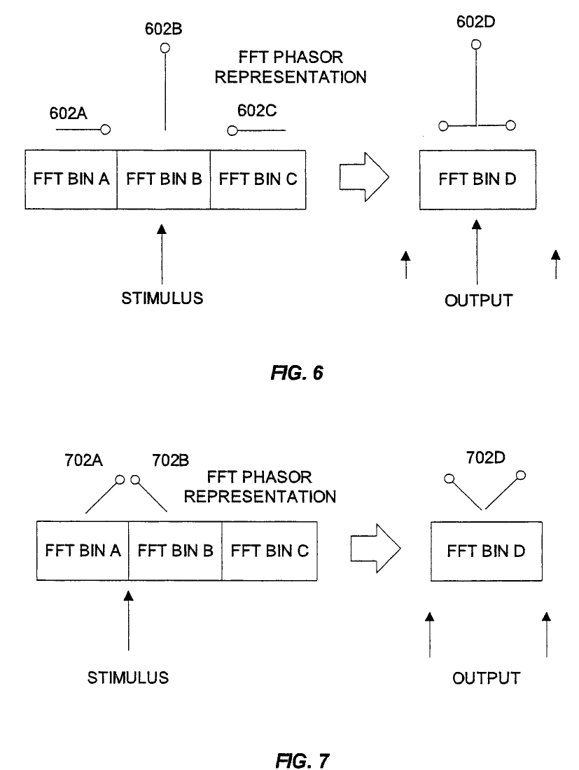

In FIG. 7, FFT bins A, B and C are again summed together to produce output bin D. A stimulus at the edge frequency of bins A and B generates phasors with a phase relationship shown at 702A and 702B. Each phasor estimates the same input frequency; phasor A at the upper edge frequency of bin A, and phasor B at the lower edge frequency of bin B. When A and B are summed together to produce D, phasor A estimates the frequency at the upper boundary of bin D, and phasor B estimates the frequency at the lower boundary of bin D. The resulting output is two frequency components at the upper and lower edge frequencies of bin D.

A “peak picking” algorithm has already been described above in connection with the discussion of feedback suppression. However, in order to improve the distortions that arise in the in the above examples, an alternative peak picking algorithm has also been devised.

In this example, the algorithm searches through each set of bins which are to be combined and selects the bin having maximum magnitude rather than summing bins together. The real and imaginary parts of the bin with maximum magnitude are transferred to the output bin (with some phase alteration if data rotation is not employed). All other bins in the group are ignored. This not only addresses the distortion problems outlined above but also solves the problem of power summation that occurs when many frequency bins are summed together. Selecting just one bin from each set rather than summing bins together ensures that the output signal power in each output bin is equal to the input bin with maximum power, which dominates the signal. This corrects for the fact that the input power from many bins is compressed into a single output bin.

This peak picking algorithm can be summarized by the following equations which show that each output bin is equal to the input bin in the contributing set which has maximum magnitude. Two alternative versions of this equation are presented below. Equation (22) includes the phase alteration term required when data rotation is not employed, whereas equation (23) presumes data rotation is employed. These equations are generic and describe how to combine frequency bins which overlap at the output, not which frequency bins are mapped to which. These equations can be used for any frequency mapping function, where a particular output bin k is created by mapping a set of input bins with indices m₁, m₂, m₃ . . . .

$$\begin{matrix}{Y}_{n} ( {ω}_{k} ) = {ⅇ}^{- j \frac{n}{D} ( {m}_{max} - k ) \frac{2 π D}{N}} {X}_{n} ( {ω}_{{m}_{max}} ) & ( 22 ) \\ {Y}_{n} ( {ω}_{k} ) = {X}_{n} ( {ω}_{{m}_{max}} ) & ( 23 )\end{matrix}$$

As will be appreciated, this bin combination technique clearly involves the overlap of several input frequency bins to one output frequency bin. The frequency ranges of several input bins are mapped to the frequency range of one output bin, so that many input frequencies will be represented at one output frequency.

In an alternative embodiment, each of a plurality of input bins are mapped to respective portions of an output bin in order to minimise or avoid overlap in frequency at the output.

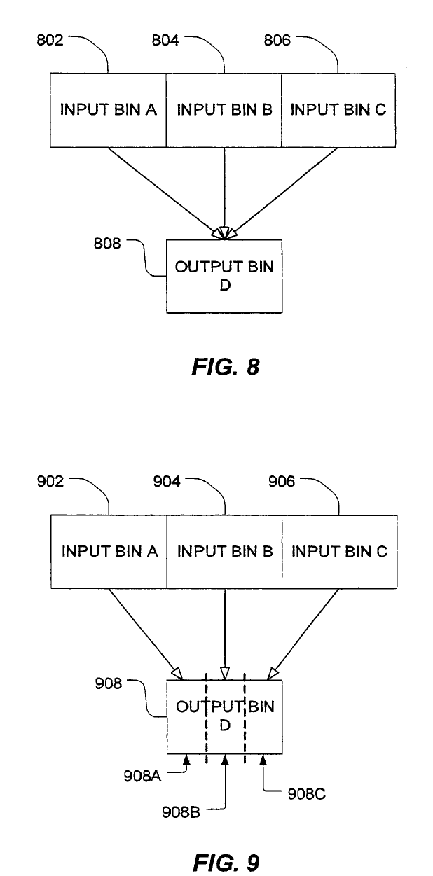

FIG. 8 illustrates a situation that arrises when performing a compressive frequency shift. In this case several input frequency bins 802, 804 and 806 are combined to produce an output bin 808. The frequency range of each input bin 802, 804, 806 is mapped to the frequency range of the output bin 808, resulting in an overlap in frequency. The affect of such an overlap is particularly noticeable when a sine sweep stimulus is used. As the input signal sweeps across a set of bins that are combined together, the output signal repeatedly sweeps across the frequency range of the output bin to which they are mapped. The present embodiment addresses this problem by achieving a frequency compression relationship without frequency overlap.

In the present embodiment, instead of mapping each bin in a contributing set to the entire frequency range of the output bin as shown in FIG. 8, each of the input bins are mapped to a portion of the output bin as illustrated in FIG. 9. In FIG. 9 the three input bins 902, 904, and 906 are combined to create an output bin 908, by mapping each input bin 902, 904, 906 to a respective third 908A, 908B and 908C of the frequency range of the output bin 908.

To implement this partial bin mapping each input bin 902, 904, 906 must be adjusted so that the frequency range of each bin is reduced in size, for example, to one third of its usual range. The phase of each bin portion 908A, 908B and 908C can then further be adjusted so that the frequency range is offset from the bin centre frequency, as is required for Input Bin A (902) and Input Bin C (906) in FIG. 9.

Thus for each data frame, a peak picking algorithm as described above, determines which of the components of the input frequency spectrum are transposed into the output bin, with the partial bin mapping scheme being used to determine where in the output bin the selected component is shifted.

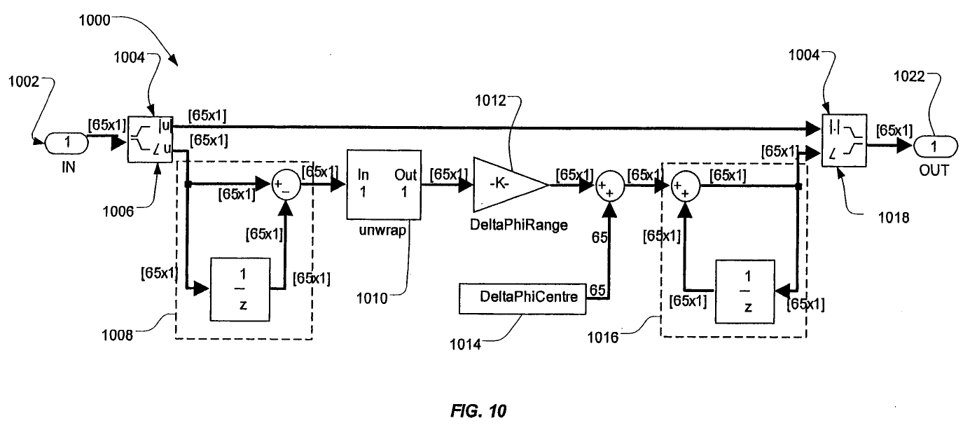

Phase vocoder theory dictates the relationship between phase change and instantaneous frequency estimation, and we use this to map the frequency to a smaller, and possibly offset, frequency range. FIG. 10 depicts a schematic block diagram of a partial bin mapping stage for conducting the phase adjustment necessary to perform this partial bin mapping. The partial bin mapping stage 1000 can be inserted in the system of FIG. 1 prior to the transposition stage 110 which effectively performs the frequency compression.

An incoming signal is sampled and a spectral representation divided into a plurality of frequency bins 1002 is generated. In the present example there are 65 frequency bins, however as will be appreciated any number of bins can be selected in other embodiments. The input signal 1002 of each bin is split into magnitude and phase components 1004 and 1006 respectively. For each frequency bin in the spectral representation block 1008 subtracts its previous phase angle from its current phase angle to determine a phase change over time as described above. The resulting phase change is unwrapped in block 1010 so the phase change value lies in the range [−π, π]. As discussed above, this unwrapped phase change value is a first order estimate of time rate of change of phase angle and using phase vocoder theory, can be used to calculate an estimate of the instantaneous frequency of each component. The frequency range of an FFT bin is 2π/N rads⁻¹, where N is the FFT length, although it is possible for the frequency estimate to be outside the confines of its own FFT bin.

It is assumed that the frequency estimate of each input bin is usually in the confines of its own bin, i.e. within the frequency range of └−π/N, π/N┘ rads⁻¹ from the bin centre frequency, and the corresponding unwrapped phase change values Δφₙ produced by block 1010 are restricted to the range Ø−πD/N, πD/N┘, where D is the forward step size (in samples) between FFT analysis frames.

Next, in blocks 1012 and 1014 the parameters DeltaPhiRange and DeltaPhiCentre are applied so as to modify the phase change values. Both quantities are 65 element vectors having one value for each input frequency bin.

In the present example, the parameter DeltaPhiRange is used to scale the phase change value of each input frequency bin to 1/M of the original range, where M is the number of bins that are combined to create a particular output bin. For example, when three bins are combined to produce an output bin, DeltaPhiRange is ⅓ and the range of each contributing bin is reduced.

The parameter DeltaPhiCentre is used to offset the frequency range from the bin centre frequency and is calculated so that each of the bins in the contributing set are distributed evenly across the frequency range └−π/N, π/N┘ rads⁻¹ of the output bin. For example, consider FIG. 9, when three input bins 902, 904, 906 are combined into one output bin 908. FFT input bin A 902 will have a DeltaPhiRange of ⅓ and a DeltaPhiCentre of

$$\frac{- 2 π D}{N} \frac{1}{3}$$

which shifts the phase change values down by one third of the output bin range, so that the resulting frequency range of Input Bin A 902 occupies the first third 908A of the frequency range of the output bin 908. Input Bin B 904 will also have a DeltaPhiRange of ⅓ since its range will be compressed but since its output will lie at the centre of the output bin 908 a DeltaPhiCentre of zero is used which produces no shift for this bin. Input Bin C 906 will have a DeltaPhiRange of ⅓ and a DeltaPhiCentre of

$$\frac{2 π D}{N} \frac{1}{3}$$

which shifts the phase change values up by one third of the output bin range so that the resulting frequency range of Input Bin C 906 occupies the upper third 908C of the frequency range of the output bin 908.

As will be appreciated the values used for DeltaPhiRange and DeltaPhiCentre will need to be selected depending on the details of the implementation, and may vary from bin-to-bin in a given implementation as discussed below.

After the phase change has been reduced in range and offset by the appropriate amount, it is then used by block 1016 to calculate the desired phase angle of the output bin by adding the phase change to the phase angle of the previous FFT frame.

The resulting phase angle 1018 is then combined with the magnitude 1004 and converted back to complex format 1022.

It should be note that in each of the above examples, three input bins were mapped to respective thirds of an output bin, however it should be noted that the partial bin mapping techniques disclosed herein should not be considered to be limited in way to this exemplary embodiment. It should be understood that there is no limitation on the number, size or placement of input or output bins that may be used in implementations of the partial bin mapping embodiments of the present invention. In some embodiments the output bin portions may be of different sizes i.e. cover different frequency ranges, to each other, e.g. a first input bin could be mapped to the first half of a given output bin, the second input bin can be mapped to next third of the output bin and the third input bin can be mapped to the remaining sixth of the output bin. Output bins can be chosen so as to overlap each other, e.g. three input bins may each be mapped to respective portions of the output bin covering half of the output bin's frequency range. In this case one of the output bin portions can be centred a quarter of the way along the output bin's frequency range, another of the output bin portions can be centred at the centre of the output bin and the last of the output bin portions can be centred three quarters of the way along the frequency range of the output bin. It is also possible that certain portions of an output bin may not have an input bin transposed into it. Other variations are also possible.

To minimise additional hardware requirements needed to implement partial bin mapping, the conversion back to real and imaginary format could be performed using a lookup table containing a set of unit vectors (in real and imaginary format) having different phases. The size of the lookup table would determine the accuracy of the phase in the converted signal. In this case, each output bin could be generated by using the calculated phase angle 1018 to index the lookup table which returns a unit vector of approximately correct phase angle. The unit vector can then be multiplied by the magnitude 1004.

In an embodiment calculations could also be reduced by examining the magnitude of each output bin and only calculating the phase for those bins which have a magnitude above a certain threshold, or within a certain threshold of adjoining bins, e.g. using spread of masking information.

A frequency shift with a frequency expansion (i.e. the opposite of frequency compression) can also be implemented using a variation on the partial bin mapping technique just described. Frequency expansion is implemented by mapping one input bin to several output bins, e.g. 1 input bin is mapped to 3 output bins. Several methods for achieving this have been described in European patent application 04/005270.6 entitled “Method for frequency transposition and use of the method in a hearing device and a communication device”, inventors Allegro, S., Timms, O., Hersbach, A. A., McDermott, H. J., Dijkstra, E.

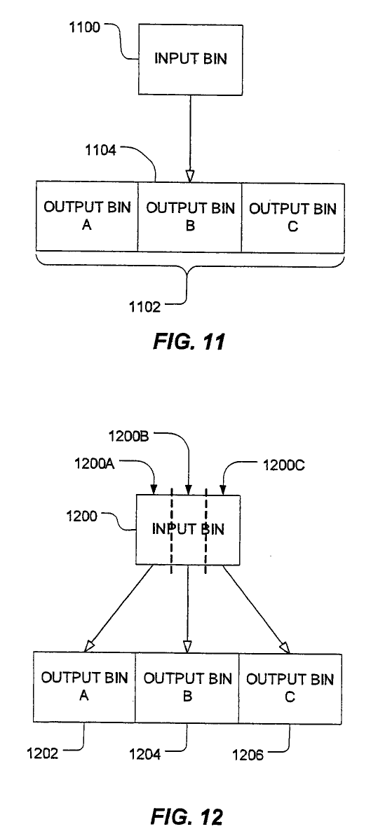

One method described therein, and as illustrated in FIG. 11 maps one input bin 1100 to an adjoining set of output bins 1102 by copying the input bin to the middle or central bin 1104 of the output bin set 1102.

A variation of the partial bin mapping technique, which is depicted in FIG. 12, may improve the results of such a frequency expansion. In FIG. 12, the input bin 1200 is divided into three partial bins 1200A, 1200B, 1200C and each third of the input bin 1200 is mapped to a respective one of three output bins 1202, 1204, 1206.

To achieve correct instantaneous frequency offsets in the output bins the phase change values can be modified by first expanding the frequency range (i.e. in the present example each third of the input FFT bin range is expanded so its range spans one entire FFT bin range) and then mapping each input bin portion to its respective output bin. A frequency offset is also applied in order to centre each expanded portion of the input bin on the centre frequency of its respective output bin.

As will be appreciated, the above technique is not limited to situations in which three input bin portions are used, but may be applied using any number of partial input bins.

It will be understood that the invention disclosed and defined in this specification extends to all alternative combinations of two or more of the individual features mentioned or evident from the text or drawings. All of these different combinations constitute various alternative aspects of the invention.

1. A method of processing a received sound signal including:
processing the received audio signal to generate an input signal spectral representation of the received signal divided into a plurality of input signal frequency bins;
transposing the input signal spectral representation from at least one input signal frequency bin into at least one output frequency bin;
applying a correction to the transposed portion of the input signal spectral representation such that a phase relationship that existed in the input signal spectral representation is substantially maintained in the transposed portion of an output signal spectral representation; and
generating a time domain output signal from the output signal spectral representation.

2. A method as claimed in claim 1 which further includes;
processing the input signal spectral representation of least one input signal frequency bin to be transposed such that the frequency range of the input signal spectral representation is altered; and
transposing the processed input signal spectral representation into a portion of at least one output frequency bin having a frequency range equal to the processed input signal spectral representation.

3. A method as claimed in claim 1 wherein the phase relationship to be maintained results in a frequency deviation of a spectral component in an input signal frequency bin from a centre frequency of said bin to be the same as a frequency deviation of a corresponding spectral component from a centre frequency of a corresponding output signal frequency bin after transposition.

4. A method as claimed in claim 2 wherein the phase relationship to be maintained results in a proportional frequency deviation of a spectral component in at least a portion of said input signal frequency bin from a centre frequency of said portion of the bin to be maintained in the processed signal spectral representation transposed into a portion of at least one output frequency bin.

5. A method as claimed in claim 1 wherein the phase correction that is applied to the transposed portion of the input signal spectral representation is equivalent to,
$$K \frac{2 π D}{N}$$
wherein, N is a number of samples in a frame of data to be processed, D is a number of samples between the start of successive frames of data to be processed, and K is a number of bins that the transposed portion of the input signal spectral representation is transposed.

6. A method as claimed in claim 1 wherein the step of applying a correction to the transposed portion of the input signal spectral representation does not include determining the phase of the spectral component of, at least one of, an input signal frequency bin or an output signal frequency bin.

7. A method as claimed in claim 1 wherein the phase correction applied is implemented by performing at least one of the following operations;
changing a sign of one or more of the real and imaginary components of the complex representation of the portion of the spectral representation to be transposed; and
swapping the real and imaginary components of the complex representation of the portion of the spectral representation to be transposed.

8. A method as claimed in claim 1 wherein processing parameters are selected such that the correction applied requires a phase shift that is an integer multiple of π/2.

9. A method of processing a received sound signal including the steps of:
processing an input data set representing the received sound signal to generate a windowed data set;
further processing the windowed data set including transposing at least one input signal frequency bin of an input signal spectral representation component derived from the windowed dataset into at least one output frequency bin to generate an output signal spectral representation including the transposed spectral representation components and in which a phase relationship that existed in the input signal spectral representation is substantially maintained;
processing the output signal spectral representation to arrive at a time domain output signal dataset.

10. A method as claimed in claim 9 wherein said further processing of the windowed data set includes:
rotating the windowed data set by a predetermined number of samples to generate a rotated windowed dataset
processing the rotated windowed dataset to generate an input signal spectral representation divided into a plurality of input signal frequency bins;
transposing the input signal spectral representation component belonging to at least one input signal frequency bin into at least one output frequency bin having a different frequency to said input frequency bin;
generating an output signal spectral representation including the transposed spectral representation components
processing the output signal spectral representation to arrive at a time domain output signal dataset; and
rotating the time domain output signal dataset by the predetermined number of samples to generate a rotated time domain output signal dataset in which a phase relationship that existed in the input signal spectral representation is substantially maintained.

11. A method as claimed in claim 9 wherein the predetermined number of samples is equal to the number of samples between the start of successive frames of data to be processed.

12. A method as claimed in claim 9 wherein the phase relationship to be maintained results in a frequency deviation of a spectral component in an input signal frequency bin from a centre frequency of said bin to be the same as a frequency deviation of a corresponding spectral component from a centre frequency of a corresponding output signal frequency bin after transposition.

13. A method of processing a received sound signal including the steps of:
processing the received audio signal to generate an input signal spectral representation of the received signal divided into a plurality of input signal frequency bins;
transposing the input signal spectral representation from at least one input signal frequency bin by a predetermined number of bins into at least one output frequency bin; such that a phase relationship that existed in the input signal spectral representation is substantially maintained in the transposed portion of the input signal spectral representation; and
generating an output signal time domain representation of the processed signal.

14. A method as claimed in claim 13 wherein respective output frequency bin is selected such that a frequency deviation of a spectral component in an input signal frequency bin from a centre frequency of said bin to be the same as a frequency deviation of a corresponding spectral component from a centre frequency of a corresponding output signal frequency bin after transposition.

15. A method as claimed in claim 13 wherein the phase relationship to be maintained results in a proportional frequency deviation of a spectral component in at least a portion of said input signal frequency bin from a centre frequency of said portion of the bin to be maintained in the processed signal spectral representation transposed into a portion of at least one output frequency bin.

16. A method as claimed in claim 1 wherein in the event that a plurality of input frequency bins are to be transposed into the same output frequency bins a peak picking algorithm is used to select a spectral component of one or more of said input bins for output in said output frequency bin.

17. A method as claimed in claim 16 wherein the peak picking algorithm sums the output corresponding to a plurality of input bins to generate the spectral component of the output frequency bin.

18. A method as claimed in claim 16 wherein the peak picking algorithm selects the input bin having the largest magnitude spectral component for output in the output frequency bin.

19. A method as claimed in claim 1 wherein the spectral representation of one input frequency bin is transposed into a plurality of output frequency bins.

20. A method as claimed in claim 19 wherein the spectral representation of each of a plurality of portions of the input frequency bin are transposed into different output frequency bins.

21. A method as claimed in claim 1 wherein the spectral representation of a plurality of input frequency bins are transposed into one output frequency bin.

22 A method as claimed in claim 21 wherein the spectral representation each of the input frequency bins are transposed into different portions of the output frequency bin.

23. A signal processing device including:
processing means for generating a spectral representation of an input sound signal
frequency transposition means for transposing at least part of the input signals spectral representation to a transposed output frequency, said frequency transposition means being configured to process the portion of the input signal spectral representation such that a phase relationship that existed in the input signal's spectral representation is substantially maintained in the transposed portion of the spectral representation; and
synthesis means for generating an output signal including the transposed portion of the input signal.

24. The signal processing device as claimed in claim 23 which further includes a spectral representation range alteration block configured to either compress or expand the frequency range of at least part of the transposed spectral representation.

25. The signal processing device as claimed in claim 23 wherein the frequency transposition means is configured to apply a correction to the transposed signal such that a frequency deviation of a spectral component in an input signal frequency bin from a centre frequency of said bin is the same as a frequency deviation of the transposed spectral component from a centre frequency of a corresponding output signal frequency bin.

26. The signal processing device of claim 24 wherein the frequency transposition means is configured to apply a correction to the transposed signal such that a proportional frequency deviation of a spectral component in an input signal frequency bin from a centre frequency of a portion of at least one said bin is the same as a proportional frequency deviation of the transposed spectral component from a centre frequency of at least one corresponding output signal frequency bin.

27. The signal processing device of claim 23 which further includes data rotation means for rotating a frame of the input signal such that a phase relationship that exists in the input signal's spectral representation will be substantially maintained in the transposed portion of the spectral representation.

28. The signal processing device of claim 27 wherein the data rotation means is further configured to rotate the transposed portion of the spectral representation prior to the generation of the output signal.

29. The signal processing device of claim 25 wherein the transposition means applies a phase correction which is equivalent to,
$$K \frac{2 π D}{N}$$
wherein, N is a number of samples in a frame of data to be processed, D is a number of samples between the start of successive frames of data to be processed, and K is a number of bins that the transposed portion of the input signal spectral representation is transposed.

30. The signal processing device of claim 23 wherein the phase relationship to be maintained results in a frequency deviation of a spectral component in an input signal frequency bin from a centre frequency of said bin to be the same as a frequency deviation of a corresponding spectral component from a centre frequency of a corresponding output signal frequency bin after transposition.
